(19) United States
(12) Patent Application Publication
(10) Pub. No.: US 2011/0188171 A1
(43) Pub. Date: Aug. 4, 2011

(54) Electric double layer capacitor and method of manufacturing the same

(75) Inventors: Sung Ho Lee, Seongnam (KR); Hong Seok Min, Yongin (KR); Sang Kyun Lee, Suwon (KR); Hyun Chul Jung, Yongin (KR); Dong Sup Park, Suwon (KR)

(73) Assignee: SAMSUNG ELECTRO-MECHANICS CO., LTD., Suwon (KR)

(21) Appl. No.: 12/926,529

(22) Filed: Nov. 23, 2010

(30) Foreign Application Priority Data
Feb. 2, 2010 (KR) 10-2010-0009685

(51) Int. Cl. H01G 9/058; H01G 7/00

(52) U.S. Cl. 361/502; 29/25.41

(57) ABSTRACT

There is provided an electric double layer capacitor and a method of manufacturing the same. The electric double layer capacitor includes first and second electrodes facing each other; and an ion-permeable separator interleaved between the first and second electrodes, wherein at least one of the first and second electrodes includes a metallic fiber being compressed to have pores therein and an electrode material filling the pores. The electric double layer capacitor has low equivalent series resistance (ESR) and high output density. Also, since the electrodes are formed to be thin, the electric double layer capacitor can be miniaturized.

### CROSS-REFERENCE TO RELATED APPLICATIONS

This application claims the priority of Korean Patent Application No. 10-2010-0009685 filed on Feb. 2, 2010, in the Korean Intellectual Property Office, the disclosure of which is incorporated herein by reference.

### BACKGROUND OF THE INVENTION

1. Field of the Invention

The present invention relates to an electric double layer capacitor and a method of manufacturing the same, and more particularly, to an electric double layer capacitor having high output density and low resistance and a method of manufacturing the same.

2. Description of the Related Art

In various electronic products such as information communication devices, a stable energy supply is considered to be an essential element. In general, such a function is performed by a capacitor. That is, the capacitor serves to store electricity in a circuit provided in various electronic products such as information communication devices and then discharge the electricity, thereby stabilizing the flow of electricity within the circuit. A general capacitor has a short charge and discharge time, a long lifespan, and high output density. However, since the general capacitor has low energy density, there is a limitation in using the capacitor as a storage device.

To overcome such a limitation, a new category of capacitors such as electric double layer capacitors have recently been developed, which have a short charge and discharge time and high output density. A great deal of attention is being paid to such capacitors as next generation energy devices together with secondary cells.

The electric double layer capacitor is an energy storage device using a pair of electrodes having different polarities. The electric double layer capacitor may perform continuous electrical charge and discharge cycles and have higher energy efficiency and output and greater durability and stability than other, more general capacitors. Accordingly, the electric double layer capacitor which may be charged and discharged with high current is being recognized as a storage device which may be charged and discharged at a high frequency, such as an auxiliary power supply for mobile phones, an auxiliary power supply for electric vehicles, and an auxiliary power supply for solar cells.

A basic structure of the electric double layer capacitor includes an electrode, an electrolyte, a current collector, and a separator. The electrode thereof has a relatively large surface area, for example, a porous electrode. The operational principle of the electric double layer capacitor is an electro-chemical mechanism in which electricity is generated when a voltage of several volts is applied to both ends of a unit cell electrode such that ions in the electrolyte move along an electric field to be adsorbed by an electrode surface.

### SUMMARY OF THE INVENTION

An aspect of the present invention provides an electric double layer capacitor having high output density and low resistance and a method of manufacturing the same.

According to an aspect of the present invention, there is provided an electric double layer capacitor including: first and second electrodes facing each other; and an ion-permeable separator interleaved between the first and second electrodes, wherein at least one of the first and second electrodes includes a metallic fiber being compressed to have pores therein and an electrode material filling the pores.

The metallic fiber may have a terminal lead-out portion which is unfilled with the electrode material.

The electrode material may be at least one selected from the group consisting of activated carbon and carbon aerogel.

The pores may be further filled with a conductive material.

According to another aspect of the present invention, there is provided a method of manufacturing an electric double layer capacitor, the method including: compressing a metallic fiber to have pores therein; preparing a first electrode by filling the pores with an electrode material; and sequentially stacking an ion-permeable separator and a second electrode on the first electrode.

The metallic fiber may be compressed to have a terminal lead-out portion which is unfilled with the electrode material.

The second electrode may be prepared by compressing a metallic fiber to have pores therein and filling the pores with an electrode material.

The metallic fiber may be compressed to have a terminal lead-out portion which is unfilled with the electrode material.

The pores may be further filled with a conductive material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic perspective view illustrating an electric double layer capacitor according to an exemplary embodiment of the present invention;

FIG. 1B is a schematic cross-sectional view illustrating the electric double layer capacitor of FIG. 1A, taken along line I-I′; and

FIGS. 2A through 2C are cross-sectional views illustrating manufacturing processes of an electric double layer capacitor according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. It should be considered that the shapes and dimensions of elements in the drawings may be exaggerated for clarity. Throughout the drawings, the same reference numerals will be used to designate the same or like elements.

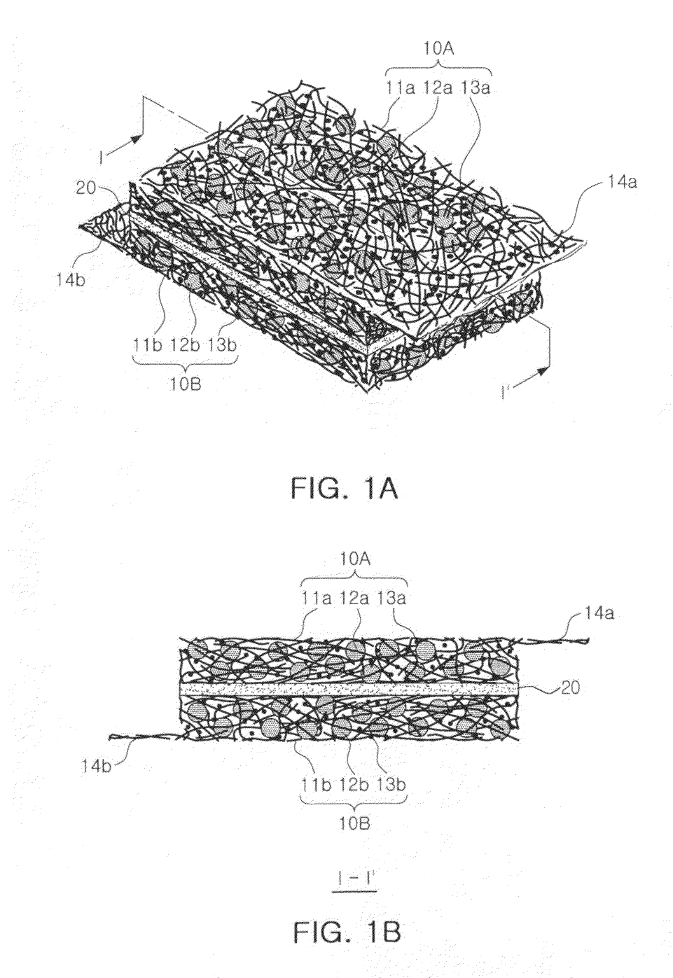

FIG. 1A is a schematic perspective view illustrating an electric double layer capacitor according to an exemplary embodiment of the present invention. FIG. 1B is a schematic cross-sectional view illustrating the electric double layer capacitor of FIG. 1A, taken along line I-I′.

With reference to FIGS. 1A and 1B, an electric double layer capacitor according to this embodiment includes first and second electrodes 10A and 10B facing each other with an ion-permeable separator 20 interleaved therebetween.

The first and second electrodes 10A and 10B and the separator 20 form a unit cell of the electric double layer capacitor. A plurality of unit cells may be stacked to obtain a higher electric capacity.

Although not shown, the electric double layer capacitor may employ a plurality of unit cells being stacked.

At least one of the first and second electrodes 10A and 10B may be formed of a metallic fiber and an electrode material. The metallic fiber may be compressed to have pores therein, and the pores may be filled with the electrode material.

Also, as shown in FIGS. 1A and 1B, the first electrode 10A may be formed of a metallic fiber 11a compressed to have pores therein and an electrode material 12a filling the pores, and the second electrode 10B may be formed of a metallic fiber 11b compressed to have pores therein and an electrode material 12b filling the pores.

Each of the metallic fibers 11a and 11b may include a single metallic fiber or a plurality of metallic fibers. The metallic fiber may be compressed to have pores therein and form the outer shape of the electrode. The diameter of the pore may be, but is not particularly limited to, for example, hundreds of μm to thousands of μm.

When a plurality of metallic fibers are employed, each metallic fiber may be compressed enough to be connected to the other fibers.

The metallic fiber may be formed of one or two kinds of metal. The metal may be, but is not particularly limited to, for example, titanium, iron, copper, aluminum, zinc, silver, cobalt, nickel, chrome, or the like.

Also, the metal may have superior conductivity and intensity and a low reactivity to the electrode material.

The length of the metallic fiber may be, but is not particularly limited to, for example, 10 μm or less.

Each of the metallic fibers 11a and 11b is compressed to have pores therein, and the pores are filled with an electrode material. That is, the electrode material is supported by the metallic fiber such that the electrode material is in contact with the metallic fiber.

An electron induced by the electrode material moves through the metallic fibers 11a and 11b. Herein, the metallic fibers 11a and 11b serve as current collectors.

The metallic fibers 11a and 11b function as a conductive path between the electrode materials 12a and 12b. An adequate conductive path between the electrode materials 12a and 12b may be obtained to thereby achieve superior current collecting properties.

The electrode materials 12a and 12b are not particularly limited, and electrode materials known in the art to which the invention pertains may be used. For example, activated carbon, carbon aerogel, or a mixture thereof may be used.

The activated carbon is not particularly limited, and it may be formed of various raw materials such as a plant-based material (such as wood or coconut husk), a coal/oil pitch-based material, a polymeric material, or a biomass material.

The carbon aerogel generally has a specific surface area lower than that of the activated carbon; however, the carbon aerogel has superior electric conductivity since the pore size thereof can be adjusted. The carbon aerogel is not particularly limited, and a carbon aerogel known in the art to which the invention pertains may be used.

Conductive materials 13a and 13b besides the electrode materials may be included in the pores provided by the metallic fibers. The conductive materials are not particularly limited, and conductive materials known in the art to which the invention pertains may be used. For example, carbon black, acetylene black, graphite or the like may be used.

Also, a binder may be included in the pores provided by the metallic fibers so as to enhance the binding of the electrode materials and the conductive materials.

The binder is not particularly limited, and a binder known in the art to which the invention pertains may be used. For example, carboxylemetyl cellulose, styrene butadiene rubber, polytetrafluoroethylene or the like may be used.

Also, the metallic fibers 11a and 11b may have first and second terminal lead-out portions 14a and 14b, respectively, which are not filled with the electrode materials.

The first and second terminal lead-out portions 14a and 14b may be connected to an external electric field, and the shapes thereof may be appropriately modified for the connection therebetween.

The shapes of the metallic fibers 11a and 11b are easily modified. Accordingly, the terminal lead-out portions 14a and 14b which are not filled with the electrode materials may be easily formed, and the shapes thereof may also be easily modified.

The separator 20 may be formed of a porous material through which ions can permeate. For example, a porous material such as polypropylene, polyethylene, or glass fiber may be used.

The separator 20 is impregnated with an electrolyte. The ions within the electrolyte pass through the separator 20 and are adsorbed onto an electrode surface.

In general, an electric double layer capacitor includes a current collector formed of a metal foil and an electrode formed on the current collector. An ion within an electrolyte is adsorbed onto an electrode surface to thereby induce an electron on the electrode surface. The induced electron moves to the current collector. At this time, the time taken for the electron to reach the current collector greatly affects the power density of the electric double layer capacitor.

In the case of using a foil-shaped current collector, the distance from the electrode surface to the current collector becomes longer, whereby the power density of the electric double layer capacitor may be reduced.

Also, a contact surface between activated carbons used as an electrode material makes the movement of the electron difficult, and a binder for the binding of the electrode materials also interferes with the movement of the electron.

In the present embodiment, however, the electrode material is directly supported by the metallic fiber, and a wide contact area between the electrode material and the metallic fiber causes the movement distance of the electron to be short. Accordingly, the electric double layer capacitor has a reduction in equivalent series resistance (ESR) and an increase in power density.

Also, since the metallic fiber serves to support the electrode material and functions as the current collector, a separate current collector is not required. Accordingly, the thickness of the electrode can be reduced, whereby the electric double layer capacitor can be miniaturized.

Hereinafter, a method of manufacturing an electric double layer capacitor according to an exemplary embodiment of the present invention will be described.

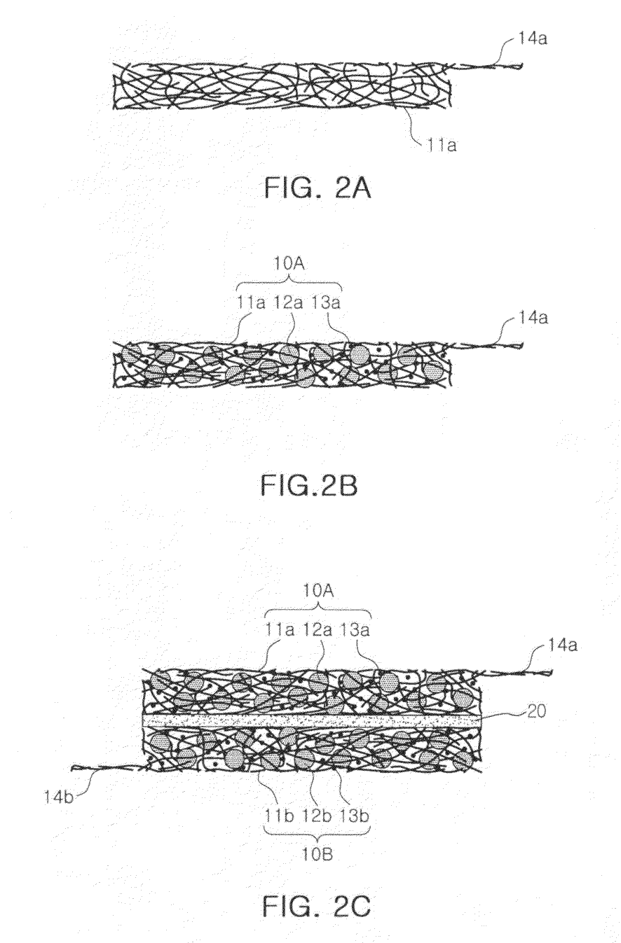

FIGS. 2A through 2C are cross-sectional views illustrating manufacturing processes of an electric double layer capacitor according to an exemplary embodiment of the present invention.

First of all, as shown in FIG. 2A, a metallic fiber 11a is compressed to have pores therein. The metallic fiber 11a forms the shape of an electrode, and its shape may be easily modified. Also, the metallic fiber 11a may be compressed to have a first terminal lead-out portion 14a which is unfilled with an electrode material.

Next, as shown in FIG. 2B, the pores provided by the metallic fiber 11a are filled with an electrode material 12a to thereby prepare a first electrode 10A. The electrode material 12a may be activated carbon or carbon aerogel as described above. Also, the pores may be further filled with a conductive material 13a.

The electrode material 12a and the conductive material 13a may form electrode material slurry. The pores provided by the metallic fiber 11a may be filled with the slurry.

Then, as shown in FIG. 2C, an ion-permeable separator 20 and a second electrode 10B are sequentially stacked on the first electrode 10A. The second electrode 10B may be prepared in the same manner as the first electrode 10A, that is, a metallic fiber lib is compressed to have pores therein and the pores are filled with an electrode material 12b. Also, the metallic fiber 11b may be compressed to have a second terminal lead-out portion 14b which is unfilled with the electrode material.

Also, the pores may be further filled with a conductive material 13b.

As set forth above, according to exemplary embodiments of the invention, an electric double layer capacitor has a reduction in ESR and an increase in power density since an electrode material is directly supported by a metallic fiber and a wide contact area between the electrode material and the metallic fiber causes the movement distance of an electron to be short.

Also, the metallic fiber functions as a conductive path of the electrode material, and thus superior current collecting properties are achieved and a separate current collector is not required. Accordingly, the thickness of an electrode can be reduced, whereby the electric double layer capacitor can be miniaturized.

While the present invention has been shown and described in connection with the exemplary embodiments, it will be apparent to those skilled in the art that modifications and variations can be made without departing from the spirit and scope of the invention as defined by the appended claims.

What is claimed is:

1. An'electric double layer capacitor comprising:
first and second electrodes facing each other; and
an ion-permeable separator interleaved between the first and second electrodes,
wherein at least one of the first and second electrodes includes a metallic fiber being compressed to have pores therein and an electrode material filling the pores.

2. The electric double layer capacitor of claim 1, wherein the metallic fiber has a terminal lead-out portion which is unfilled with the electrode material.

3. The electric double layer capacitor of claim 1, wherein the electrode material is at least one selected from the group consisting of activated carbon and carbon aerogel.

4. The electric double layer capacitor of claim 1, wherein the pores are further filled with a conductive material.

5. A method of manufacturing an electric double layer capacitor, the method comprising:
compressing a metallic fiber to have pores therein;
preparing a first electrode by filling the pores with an electrode material; and
sequentially stacking an ion-permeable separator and a second electrode on the first electrode.

6. The method of claim 5, wherein the metallic fiber is compressed to have a terminal lead-out portion which is unfilled with the electrode material.

7. The method of claim 5, wherein the second electrode is prepared by compressing a metallic fiber to have pores therein and filling the pores with an electrode material.

8. The method of claim 7, wherein the metallic fiber is compressed to have a terminal lead-out portion which is unfilled with the electrode material.

9. The method of claim 5, wherein the pores are further filled with a conductive material.

10. The method of claim 7, wherein the pores are further filled with a conductive material.
